(19) United States
(12) Patent Application Publication
(10) Pub. No.: US 2006/0075883 A1
(43) Pub. Date: Apr. 13, 2006

(54) Audio signal analysing method and apparatus

(75) Inventors: Christopher Thorne, East Croydon (GB); Richard S Cole, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/537,618

(22) PCT Filed: Dec. 10, 2003
(86) PCT No.: PCT/IB03/05960

§ 371 Date: Jun. 3, 2005

(30) Foreign Application Priority Data
Dec. 20, 2002 (GB) 0229940.2

(51) Int. Cl. G10H 7/00; G10H 1/26; A63H 5/00; G10H 5/00

(52) U.S. Cl. 84/616; 84/649

(57) ABSTRACT

A method for determining the key of an audio signal such as a music track. Portions (106) of the audio signal are analysed (104) to identify (108) a musical note and its associated strength (110) within each portion. Some notes identified in a portion may be ignored (118) to enable notes related to the key to be more readily distinguished. A first note is then determined (124) from the identified musical notes as a function of their respective strengths. From the identified musical notes, at least two further notes are selected (128) as a function of the first note. The key of the audio signal is then determined (130) based on a comparison of the respective strengths of the selected notes.

The present invention relates to a method and apparatus for determining a feature of an audio signal, in particular the musical key.

With the advent of cheaper storage and access to the Internet, consumers can access and accumulate vast amounts of information and content including video, audio, text and graphics. There is a recognised need for classification in order to facilitate search and access of such content by consumers. In an audio context, classification may be performed on the basis of music genre, artist, composer and the like. These classifications however may be limiting where selection is on the basis of mood or other emotionally-specific criteria. For example romantic music can be considered to span a range of composers and musical styles within classical, popular and other musical traditions. Emotional music may be characterised in terms of its inherent musical features including level, tempo and key, each of which is independent of a specific genre, composer or similar classification.

In U.S. Pat. No. 5,038,658 to Tsuruta et al, an automatic music transcription method and apparatus capable of determining the key of acoustic signals is disclosed. A disadvantage of the method employed is the need to perform multiple segmentation of the acoustic signal in order to determine musical intervals necessary to determine the key, including segmentation on the basis of changes in the obtained power information, on the basis of standard note lengths and on the basis of whether or not the musical interval of the identified segments in continuum are identical. A further disadvantage of the method is the need to extract the pitch information in the time domain by means of autocorrelation.

In paper “Querying Large Collections of Music for Similarity” (Welsh et al, UC Berkeley Technical Report UCB/CSD-00-1096, November, 1999), a system capable of performing queries against a large archive of digital music is presented using a technique based on a set of feature extractors which pre-process a music archive. One feature extractor produces a histogram of frequency amplitudes across notes of a music scale, each bucket of the histogram corresponding to the average amplitude of a particular note (e.g. C sharp) across 5 octaves for the sample of music analysed. It is stated that this information can be used to help determine the key that the music was played in, however a method is not disclosed. A further disadvantage of the approach is a potential difficulty to discriminate from the averaged note data those notes that are related to the key of the music.

It is an object of the present invention to improve on the known art.

In accordance with a first aspect of the invention there is provided a method for determining the key of an audio signal, the method comprising the steps of:
for each of a plurality of signal portions, analysing the portion to identify a musical note, and where at least one musical note is identified:
   determining a strength associated with the or each musical note; and
   generating a data record containing the identity of the or each musical note, the strength associated w ith the or each m usical note and the identity of the portion;
for each of the data records, ignoring the strength associated with an identified musical note where said strength is less than a predetermined fraction of the maximum strength associated with any identified musical note contained within the data records;
determining a first note from the identified musical notes as a function of their respective strengths;
selecting at least a second and a third note from the identified musical notes as a function of the first note; and
determining the key based on a comparison of the respective strengths of the at least second and third notes.

In accordance with a second aspect of the invention there is provided an apparatus for determining the key of an audio signal, the apparatus comprising:
an input device operable to receive a signal;
a data processing apparatus operable to:
   for each of a plurality of signal portions, analyse the portion to identify a musical note, and where at least one musical note is identified:
      determine a strength associated with the or each musical note; and
      generate a data record containing the identity of the or each musical note, the strength associated with the or each musical note and the identity of the portion;
   for each of the data records, ignore the strength associated with an identified musical note where said strength is less than a predetermined fraction of the maximum strength associated with any identified musical note contained within the data records;
   determine a first note from the identified musical notes as a function of their respective strengths;
   select at least a second and a third note from the identified musical notes as a function of the first note; and
   determine the key based on a comparison of the respective strengths of the at least second and third notes.

Owing to the invention it is possible to determine the key of an audio signal in an efficient and accurate manner. The audio signal may be a digital or analogue recording of a piece of music.

Preferably each portion is the same size, and each portion encompasses the same length of time. Advantageously the size of the portion is a function of the tempo of the audio signal. The portions may be contiguous. Preferably, the predetermined fraction is determined in dependence on the content of the audio signal. Ideally, the predetermined fraction lies in the range of one tenth to one half, with a preferred embodiment of the predetermined fraction being one seventh.

Advantageously, the step of analysing the portion to identify a musical note comprises the steps of:
converting the portion to a frequency domain representation;
subdividing the frequency domain representation into a plurality of octaves;
for each octave containing a maximum amplitude:
   determining a frequency value at the maximum amplitude; and
   selecting a note name of a musical scale in dependence on the frequency value;
and
identifying a musical note in dependence on the same note name being selected in more than one octave.

In this embodiment, the conversion of the portion to a frequency domain representation is preferably performed by means of a Fourier Transform. The musical scale is ideally the Equal Tempered Scale.

In a preferred embodiment, the step of determining a strength associated with the musical note comprises the steps of:
determining the amplitude of each frequency component of the musical note; and
summing the amplitudes.

Advantageously, the step of determining the first note comprises the steps of:
for each identified musical note, summing the strengths associated with the musical note in the data records; and
determining the first note to be the identified musical note with the maximum summed strength.

In a preferred embodiment, the first note is the tonic of the key.

An advantage of the present invention is that portions of the audio signal used for analysis may be selected arbitrarily and such selection is thus independent of the content of the audio signal. Furthermore, the method of the invention relies on detecting the presence of musical notes which are related to the key of the audio signal, preferably detecting notes originating from a particular type of musical source (e.g. instrument). Advantageously, determining the timing and duration of musical notes is not relevant to the method. A further advantage is that filtering is applied to eliminate contributions from irrelevant notes (and noise) which otherwise confuse the process of determining the identities of the notes of interest. Moreover, the method of the invention is suitable for implementation in low cost hardware and/or software thereby enabling deployment in high volume consumer products.

Embodiments of the invention will now be described, by way of example only, with reference to the accompanying drawings in which:

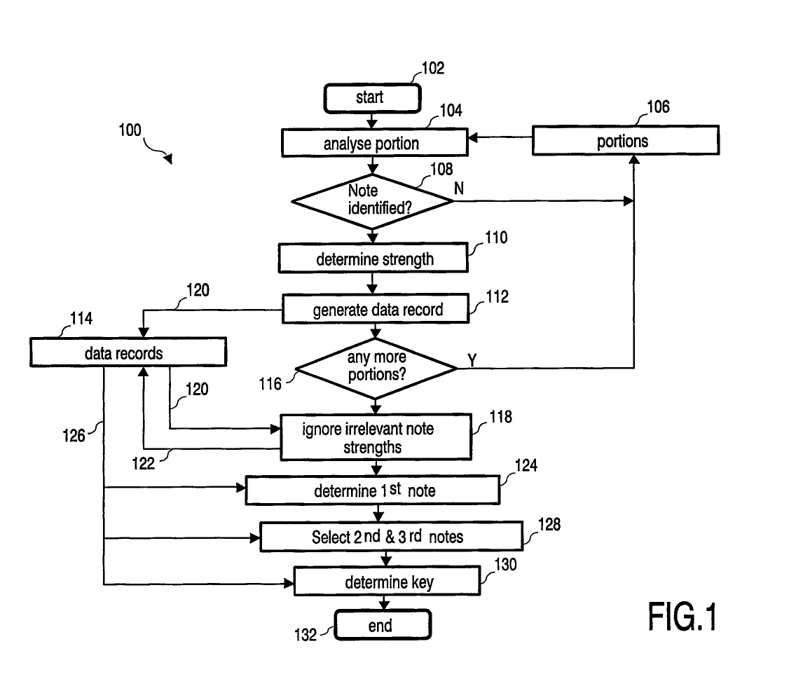

FIG. 1 is a flow diagram of a method for determining the key of an audio signal;

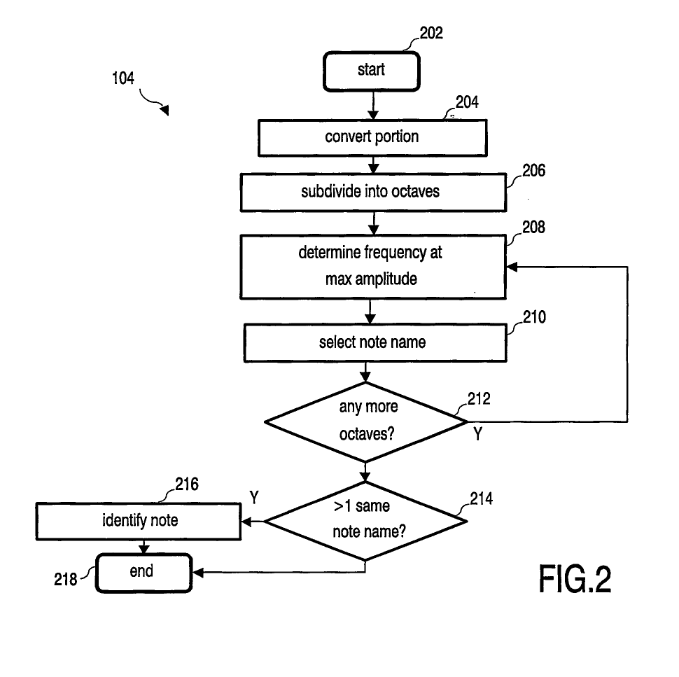

FIG. 2 is a flow diagram of a step in the method of FIG. 1 for analysing a portion of the audio signal;

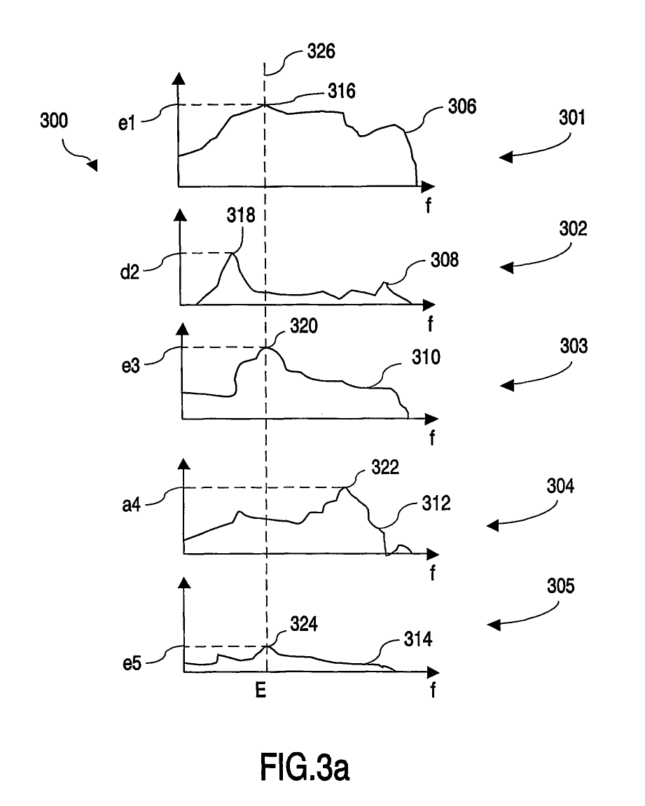

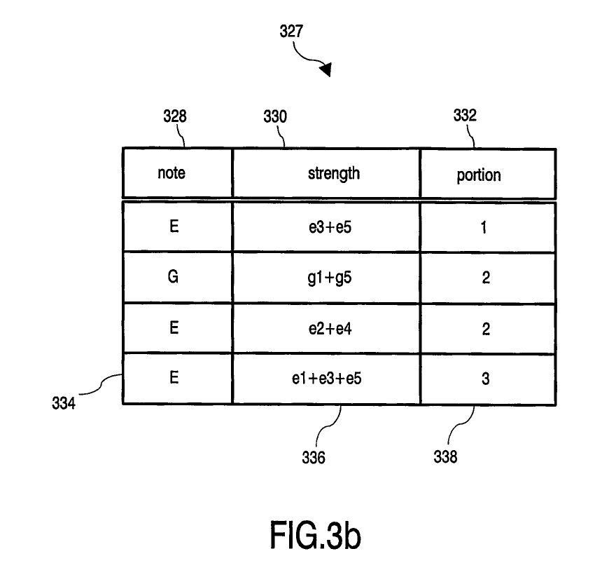

FIG. 3a is a series of graphs showing an example of a frequency domain representation of a portion of the audio signal;

FIG. 3b is a table showing a set of data records corresponding to portions of the audio signal including the portion represented in FIG. 3a;

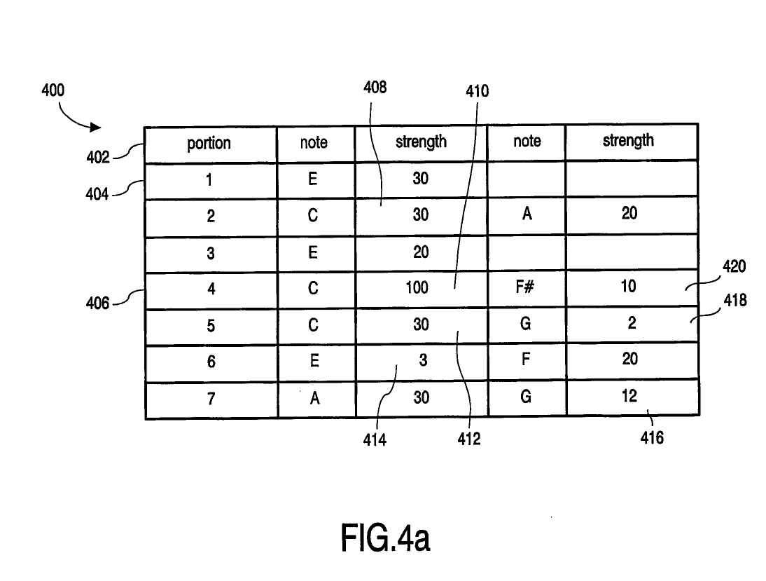

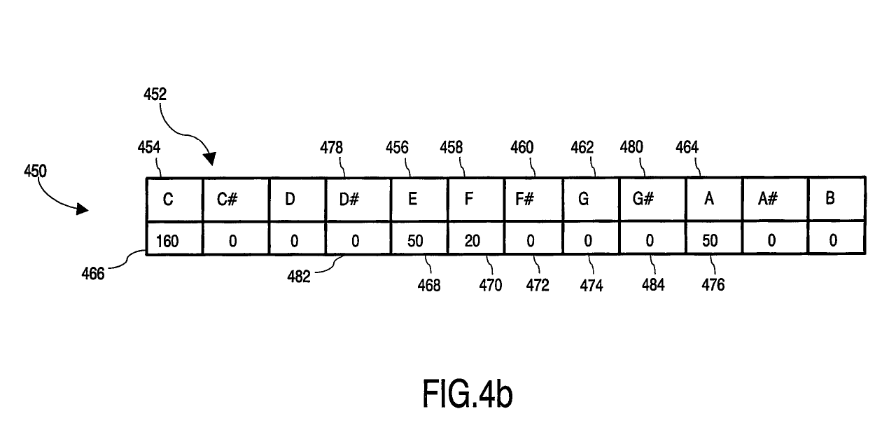

FIG. 4a is a table showing a set of data records corresponding to portions of the audio signal;

FIG. 4b is a table showing total strengths associated with identified notes as derived from the data within the table of FIG. 4a; and

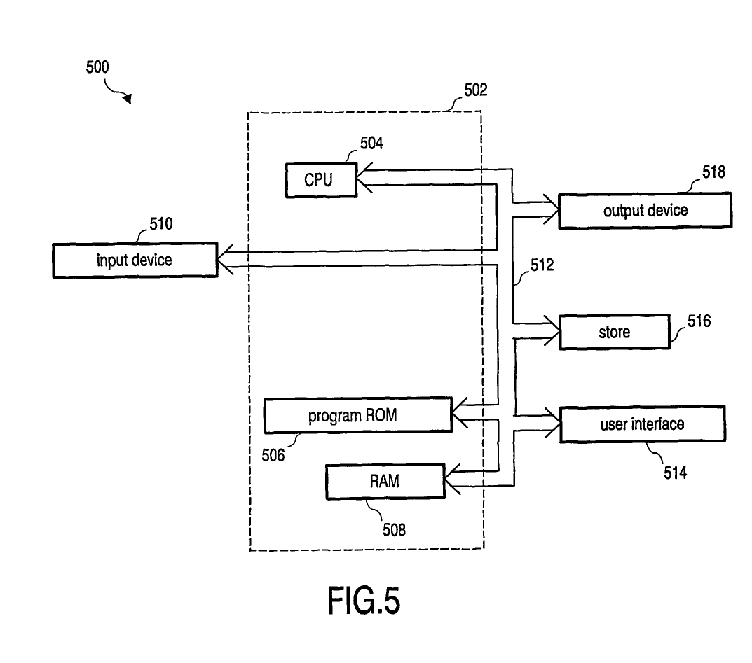

FIG. 5 is a schematic representation of an apparatus for determining the key of an audio signal.

FIG. 1 shows a flow diagram of a method for determining the key of an audio signal. Typically, the audio signal is received by an input device (510, FIG. 5) of an apparatus (500, FIG. 5) which carries out this method. The method, shown generally at 100, starts at 102 and analyses 104 a portion of the audio signal to identify a musical note (as described in more detail below). Preferably, the key is determined using identified bass musical notes. These notes can be characterised by their fundamental components residing within the bass register and having one or more harmonically related frequency components, the components correlating with a recognised musical scale. Such notes may be sounded by a pitched instrument (that is, an instrument which can sound one or more notes according to a musical scale), for example a bass guitar or double bass. Where at least one musical note has been identified 108 for the portion, the method then determines 110 a strength associated with the musical note or notes. The strength is determined as a function of the amplitude of one or more frequency components of the identified musical note. Once the strength associated with each musical note within a portion has been determined, a data record 120 is generated 112 comprising the identity of the musical note or notes, the strength associated with each musical note and the identity of the portion. The method then checks 116 to ensure that steps 104, 108, 110 and 112 are performed for all portions 106 of the audio signal that are to be processed. It is to be noted that the portions may encompass only part of the total received audio signal and that the portions may or may not be contiguous. Each data record 120 of the resulting set 114 of data records is reviewed in order to ignore 118 any strength within the record which is less than a predetermined fraction (e.g. one seventh) of the maximum strength associated with any identified musical note contained in any record within the set of data records. Such strengths can be deleted 122 from the data records. The purpose is to filter out those note strengths which may affect the discrimination of notes within the audio signal which are related to the key. Next, the method determines 124, using filtered data 126, a first note from the identified musical notes as a function of their respective strengths. Then, at least a second and a third note are selected 128 from the identified musical notes as a function of the first note, a gain using filtered data 126. The notes selected depend on the musical scale employed in the analysis. Preferably, the Equal Tempered Scale is used. For this scale system, the first note would represent the tonic of the scale and the second and third notes could respectively represent alternative interval notes, each corresponding to the major and minor modes of the key. Additional notes may be selected depending on the modality of the key to be determined. The key is then determined 130 based on a comparison of the respective strengths of at least the second and third notes. The method ends at 132.

FIG. 2 shows a flow diagram describing in greater detail the step 104 in the method of FIG. 1 for analysing a portion of the audio signal. The method starts at 202 and proceeds to convert 204 the portion to a frequency domain representation. Any suitable means of conversion may be used; preferably, the conversion is performed by means of a Fourier Transform. Next, the frequency representation is subdivided 206 into a number of octaves since musical scales can be constructed using octaves. Any suitable musical scale may be employed; preferably the Equal Tempered Scale is used since this musical scale is commonly the basis of many music genres and styles. A maximum amplitude frequency component is searched for within each octave. Where such a maximum exists the frequency value at the maximum amplitude is determined 208. A note name of a musical scale (for example, the Equal Tempered Scale) is then selected 210 according to the determined frequency value. The determined frequency value should correspond exactly to, or at least within a predetermined range (e.g. +/−10%) of, the reference frequency value of a musical scale note with a specified note name.

The particular predetermined range chosen may be dependent on the frequency tolerance of the musical notes within the audio signal; the frequency tolerance in turn may be influenced by for example the musical source or sources not being in tune with the reference tuning of the musical scale. The difference in tuning can be measured and the predetermined range chosen accordingly to compensate. Distortions can occur in the path from the musical sources to the key determining method or apparatus. Types of distortion in the path include wow and flutter, data corruption and noise. As such distortions may vary with time, a nominal predetermined range such as +/−10% could be chosen or a more complex scheme might be employed to continuously measure the distortion and dynamically adapt the predetermined range.

A note name of a musical scale describes all notes related in terms of octave multiples (that is, notes with the same name are harmonically related); a specific note within a scale may be characterised by a note name and a particular octave. The method checks 212 to ensure all the octaves of the frequency domain representation of the portion are processed by steps 208 and 210. Note names selected in the octaves are then compared 214; where two or more same note names occur they are deemed to identify 216 a musical note. This is because musical sources such as vocalists and instruments can produce sounds characterised by a set of frequency components which are harmonically related; that is, the frequency components of a note sounded by such a musical source are positioned at multiples of one another. The method ends at 218.

It will be evident to the skilled person that the method may potentially identify none, one or more musical notes for a portion. In the case where the frequency domain representation of a portion is subdivided into a number of octaves, the ability to identify more than one musical note is dependent on the number of octaves into which the frequency domain representation of a portion is subdivided; two or three octaves can identify up to one musical note; four or five octaves can identify up to two musical notes, and so on. The range of notes produced by a musical source may influence the number of octaves the frequency domain representation of a portion should be subdivided into. As an example, an audio signal may comprise musical notes residing within the frequency range 27 Hz to 4.1 kHz (e.g. a pianoforte capable of sounding notes from A0 to C8 of the Equal Tempered Scale). In this example, the method would subdivide the frequency domain representation of a portion of the audio signal into, say, at least one or two further octaves (e.g. 11 octaves in total—octaves 0 to 10 of the Equal Tempered Scale) in order to identify the high pitch notes of the piano. However, this holistic approach is unnecessary for the purpose of key determination and a subset of octaves is preferably used. For example a musical source with a particular register may be used to determine the key. Preferably, the audio signal comprises bass notes and the method can subdivide the frequency domain representation of a portion of the audio signal into five octaves (for example, octaves 1 to 5 of the Equal Tempered Scale) in order to identify the bass notes.

FIG. 3a is a series of graphs showing an example of a frequency domain representation 300 of a portion of the audio signal. The frequency domain representation is subdivided into a number of octaves. In FIG. 3a five amplitude-frequency graphical representations 301, 302, 303, 304, 305 are shown, each representing one octave in scale (logarithmically in the horizontal frequency axis). The octaves are chosen such that they encompass a range of frequencies in which suitable components of the sounded musical notes, if present in the portion, will reside. Preferably, bass musical notes are to be identified; therefore, suitable octaves include those which encompass the fundamental and harmonic components of notes produced by bass instruments, for example in the case of the Equal Tempered Scale, octave numbers 1 to 5. The amplitude outline of frequency components of the portion within each octave are shown as 306, 308, 310, 312, 314. Each of these outlines is reviewed to detect a maximum (if present). In the example shown, each octave has a maximum, shown at 316, 318, 320, 322, 324 respectively. In FIG. 3a, each amplitude-frequency graphical representation 301 to 305 is arranged to cover the same note sequence for one octave of the Equal Tempered Scale; for example the frequency value (in an octave) for note C lies at the origin, with the frequency axis scale covering one octave. Maxima 316, 320 and 324 all relate to the same note name, E, as depicted by line 326 which represents the same note name (E) common to all the octaves (since each octave is depicted using a logarithmic frequency axis and the representations 301-305 being arranged vertically as shown). Therefore, note E occurs (i.e. is a maximum frequency component) in more than one octave (actually three octaves). Note E is therefore deemed to be identified. A strength associated with the identified note E is then determined by summing the amplitudes of frequency components in octaves in which the note name corresponds to the maximum amplitude. In the present example, the strength comprises the sum of the amplitude values e1, e3, e5 of the relevant (maximum) frequency components of the note in the respective octaves. Reviewing the other octaves, it can be seen that there is no same note correspondence of maxima 318 and 322, these being respectively a frequency component of note D (with amplitude d2) and a frequency component of note A (with amplitude a4).

FIG. 3b shows a table containing a set of data records corresponding to portions of the audio signal including the portion represented in FIG. 3a. A set of data records 327 is created during the analysis of portions of the audio signal. Each record includes fields to identify the note 328, a strength 330 associated with the note and the portion 332 in which the note was identified. As previously discussed, more than one note may be identified within a portion; FIG. 3b provides such an illustration in the case of data records for the portion numbered 2. A data record for the portion represented in FIG. 3a is shown and includes the identity 334 of the identified note, the calculated strength 336 associated with the note and the identity 338 of the portion.

Considering the example where notes are identified within the five octaves 1 to 5 of the Equal Tempered Scale, it is likely the strongest identified musical note occurring in any portion is due to:
a) a bass note having components with significant amplitudes in most of the five octaves, and/or b) a higher pitched note with large amplitude components in the upper octaves (e.g. octaves 4 and 5).

Suitable selection of portion size may help to discriminate between these notes. As portion size increases, the number of identifiable notes within a portion may increase. Recalling that to identify more than one musical note for a portion depends on the number of octaves into which the frequency domain representation of that portion is subdivided, then for a given number of octaves, a larger portion size reduces the ability to identify all the musical notes that are present. Conversely, in order to minimise the influence of strong notes in the higher part of the bass register (e.g. octaves 4 and 5), the portion size should suitably be selected such that bass notes and strong higher notes may less often occupy the same portion. The size of portions may be variable or fixed. An advantage of using a fixed portion size is a reduced processing requirement (resulting in faster execution). Preferably, each portion is the same size, for example each portion encompasses the same length of time. Selection of portion size can be a function of the tempo (beat rate) of an audio signal. Where the tempo is unknown, portion size might be selected as a function of the maximum expected tempo, for example 240 beats per minute. It may be further refined by assuming a maximum number of distinctly played notes per beat, such as two notes per beat. For example, an audio signal comprising 44100 samples per second might be analysed in portions each having a size of 5512 samples representing one eighth of a second which corresponds to a tempo of 240 beats per minute with a maximum of two distinctly played notes (i.e. quavers) per beat. In this example, for convenience the portion size might be rounded down to 5000 samples.

FIG. 4a is a table showing a set of data records corresponding to portions of the audio signal. A data record 402 includes fields to identify the portion in which one or two notes were identified and the strength associated with each note. Data record 404 relates to portion 1 and identifies one note (E) with an associated strength (30). Similarly, data record 406 relates to portion 4 and identifies two notes (C and F sharp, F#) with associated strengths (100 and 10 respectively).

The set of data records comprises records for a number of portions, each data record comprising note and strength data for a particular portion, as discussed. The method now filters out certain identified musical notes within the data records, for example by ignoring the strength associated with a note of a portion which is less than a predetermined fraction of the strongest identified musical note occurring in any portion. The filtering helps to emphasise for example stronger notes within the audio signal, such notes tending to be more related to the key. In the example case where bass notes are identified, an ignored strength associated with a note of a portion may include a note having relatively little bass content (for example only having contributions within the higher octaves of the frequency domain representation of the portion) or a note with relatively low bass level such that it makes little overall contribution (e.g. a relatively quiet note, or noise). The predetermined fraction may lie in the range of one tenth to one half of the strongest identified note of any portion. The predetermined fraction can be determined in dependence on the content of the audio signal, for example a first piece of music having more instruments playing within the bass register (compared to a second piece of music) may require different filtering (fraction) compared to the second piece. The predetermined fraction selected may be dependent on a music genre; for example a suitable predetermined fraction for popular music is one seventh. Preferably, one seventh is used as the default value for the predetermined fraction. In cases where the default value of one seventh gives poor results in terms of determining the key, alternative filtering might be performed using a different fraction value. Selection of a suitable fraction value can be made empirically or based according to the content or genre of the audio signal as discussed above.

In the example of FIG. 4a, the audio signal is known to be popular music and so the predetermined fraction of one seventh is used. The maximum strength in the set of data records 400 is 100 (the strength 410 associated with the identified note C in portion 4). Therefore strengths 414, 416, 418, 420 within the set of data records 400 are each less than 100/7 and will be ignored in subsequent processing, for example by being deleted (not shown in FIG. 4a) from their respective data record within the set of data records 400. A first musical note is then determined from the identified notes as a function of their respective strengths. An example may comprise taking the strengths of the identified notes of each portion having the same note name and calculating the total strength of each identified note of the musical scale across all the portions.

FIG. 4 b is a table showing total strengths associated with identified notes as derived from the data within the table of FIG. 4a. Each total strength calculated corresponds to one of the twelve notes 452 of the chromatic scale of the Equal Tempered Scale. The identified note having the highest total strength is deemed to be the first note (which in this example is the tonic) related to the musical key of the audio signal. Second and third notes are selected by their relation to the tonic such that their relative strength indicates whether the mode of the key is major or minor. For example, for the scale of which the tonic is the key note, the 3^{rd} step (interval) of the scale may be examined. Where the analysed portions of the audio signal are mainly in a major key there will be stronger occurrences of the 4^{th} semitone up from the tonic (for example, where the tonic is the note C, the 4^{th} semitone of C major is the note named E natural). Alternatively, where the analysed portions of the audio signal are mainly in a minor key there will be stronger occurrences of the 3^{rd} semitone up from the tonic (for example, where the tonic is the note C, the 3^{rd} semitone of C minor is the note named D sharp, D#). Therefore, for the present example, comparing the relative total strengths of identified notes at the 4^{th} and 3^{rd} semitone up from the tonic should indicate whether the key is major or minor (for the key of C, comparing identified notes E and D#). Alternative notes could be examined to determine major and minor including notes of the 6^{th} interval (for example, for the key of C, comparing identified notes A natural and G sharp, G#). In FIG. 4b, identified note C 454 has the highest total strength 466 (comprising the addition of strengths 408, 410, 412) and is therefore deemed to be the first note (and tonic). Other identified notes, as contained in the set of data records 400, comprise notes 456, 458, 460, 462, 464, with corresponding (filtered) strengths 468, 470, 472, 474, 476. It can be seen that, for example, the total strength 470 of note 458 excludes the contribution 420 since this is considered to be an irrelevant note or noise and is therefore filtered out (ignored). As discussed above, further identified notes are then selected as a function of the tonic, for example the 3^{rd} and 6^{th} musical intervals. The method selects identified musical notes 456, 478 (or alternatively 464, 480) corresponding to the 3^{rd} (or 6^{th}) musical intervals based on the tonic. A comparison of the total strength 468, 482 (or alternatively 476, 484) of each selected identified musical note is used to determine the major or minor mode of the musical key of the audio signal. In the example of FIG. 4b, the tonic of the key is C (largest total strength of 160); comparing the total strengths 468 and 482 of the respective major and minor 3^{rd} interval notes 456 and 478, it can be determined that the key is C major. It is to be observed that a key may have a modality of a type which requires the selection of additional or alternative identified notes to those described in order to fully determine the mode of the key.

FIG. 5 is a schematic representation of an apparatus, shown generally at 500, for determining the key of an audio signal. The apparatus comprises an input device 510 which is used to receive an audio signal. The input device might include an interface to read physical media (magnetic tape, magnetic or optical disc, etc.) or perhaps to interface to a wired and/or wireless network, thereby enabling access to local and remote network sources, including Internet sources. In particular, examples of suitable wired systems include Ethernet, RS232 and USB; examples of suitable wireless systems include WiFi, 802.11b, Low Power radio and Bluetooth. The audio signal may comprise any suitable analogue or digital format. The received audio signal may be baseband or modulated. Examples of suitable digital audio signal formats include AES/EBU, CD audio, WAV and AIFF. The input device may perform processing in order to present the audio signal in a form suitable for the data processing apparatus 502 section of the apparatus. The apparatus also comprises a CPU 504, program ROM 506, RAM 508 (which together constitute data processing apparatus 502) which are interconnected and communicate with input device 510 via bus 512. The program ROM includes code which when run by the CPU is operable to execute the method steps. The program code might alternatively be downloaded from a source remote to the apparatus via the input device and stored in local storage such as the RAM 508. The RAM is generally used to hold temporary results. The input device 510 and/or the data processing apparatus 502 may be implemented in hardware or software or any combination of these. For example, an ASIC may implement the functions of the input device and/or data processing apparatus. In another example, the input device might be a wireless air interface and the data processing apparatus implemented using conventional CPU, ROM and RAM. A user interface 514 could be connected to the data processing apparatus via bus 512 and this interface can then be used to enable a user to configure the method, for example to select a type of music mood required (sad, happy, etc.) which selection might be used to establish which musical keys to look for. Store 516 can contain a list of audio signal identifiers (e.g. data describing the locations of audio signals) or audio signal files (for example music tracks) together with their musical keys (as determined from prior analysis, for example by the apparatus). In response to user input or by any other way, the apparatus accesses and analyses audio signals and/or selects audio signals based on one or more determined keys for a purpose such as compiling a playlist, which playlist is compiled according to the input information including mood, situation, etc. The apparatus can access and analyse audio signals from remote sources to offer tracks according to the input information. In another case the apparatus can output musical key and audio signal information via output device 518 for use by another apparatus or system. The output device can comprise any suitable implementation, including those mentioned above in respect of the input device, for interfacing to physical media and/or network entities.

The invention may be incorporated within any suitable apparatus configured as a dedicated key extraction apparatus or to provide key extraction features within a host product or application. Examples of suitable apparatus include audio Jukebox, Internet radio and playlist generators (e.g. for radio station use). Audio Jukeboxes may access audio signals using removable media (utilising magnetic tape/disc and/or optical disc) and/or via networking technologies (local and wide area, including Internet, etc.) by means of wired or wireless interconnection.

The foregoing method and implementation are presented by way of example only and represent a selection of a range of methods and implementations that can readily be identified by a person skilled in the art to exploit the advantages of the present invention.

In the description above and with reference to FIG. 1 there is disclosed a method for determining the key of an audio signal such as a music track. Portions 106 of the audio signal are analysed 104 to identify 108 a musical note and its associated strength 110 within each portion. Some notes identified in a portion may be ignored 118 to enable notes related to the key to be more readily distinguished. A first note is then determined 124 from the identified musical notes as a function of their respective strengths. From the identified musical notes, at least two further notes are selected 128 as a function of the first note. The key of the audio signal is then determined 130 based on a comparison of the respective strengths of the selected notes.

1. A method for determining the key of an audio signal, the method comprising the steps of:
for each of a plurality of signal portions, analysing the portion to identify [p v1]a musical note, and where at least one musical note is identified:
determining a strength associated with the or each musical note; and
generating a data record containing the identity of the or each musical note, the strength associated with the or each musical note and the identity of the portion;
for each of the data records, ignoring the strength associated with an identified musical note where said strength is less than a predetermined fraction of the maximum strength associated with any identified musical note contained within the data records;
determining a first note from the identified musical notes as a function of their respective strengths;
selecting at least a second and a third note from the identified musical notes as a function of the first note; and
determining the key based on a comparison of the respective strengths of the at least second and third notes.

2. A method as claimed in claim 1, wherein each portion is the same size.

3. A method as claimed in claim 1, wherein each portion encompasses the same length of time.

4. A method as claimed in claim 1, wherein the size of the portion is a function of the tempo of the audio signal.

5. A method as claimed in claim 1, wherein the portions are contiguous.

6. A method as claimed in claim 1, wherein the predetermined fraction is determined in dependence on the content of the audio signal.

7. A method as claimed in claim 1, wherein the predetermined fraction lies in the range of one tenth to one half.

8. A method as claimed in claim 7, wherein the predetermined fraction is one seventh.

9. A method as claimed in claim 1, wherein the step of analysing the portion to identify a musical note comprises the steps of:
converting the portion to a frequency domain representation;
subdividing the frequency domain representation into a plurality of octaves;
for each octave containing a maximum amplitude:
determining a frequency value at the maximum amplitude; and
selecting a note name of a musical scale in dependence on the frequency value;
and
identifying a musical note in dependence on the same note name being selected in more than one octave.

10. A method as claimed in claim 9, wherein the conversion of the portion to a frequency domain representation is performed by means of a Fourier Transform.

11. A method as claimed in claim 9, wherein the musical scale is the Equal Tempered Scale.

12. A method as claimed in claim 1, wherein the step of determining a strength associated with the or each musical note comprises the steps of:
determining the amplitude of each frequency component of the musical note; and
summing the amplitudes.

13. A method as claimed in claim 1, wherein the step of determining the first note comprises the steps of:
for each identified musical note, summing the strengths associated with the musical note in the data records; and
determining the first note to be the identified musical note with the maximum summed strength.

14. A method as claimed in claim 1, wherein the first note is the tonic of the key.

15. An apparatus for determining the key of an audio signal, the apparatus comprising:
an input device operable to receive a signal;
a data processing apparatus operable to:
for each of a plurality of signal portions, analyse the portion to identify [p v2]a musical note, and where at least one musical note is identified:
determine a strength associated with the or each musical note; and
generate a data record containing the identity of the or each musical note, the strength associated with the or each musical note and the identity of the portion;
for each of the data records, ignore the strength associated with an identified musical note where said strength is less than a predetermined fraction of the maximum strength associated with any identified musical note contained within the data records;
determine a first note from the identified musical notes as a function of their respective strengths;
select at least a second and a third note from the identified musical notes as a function of the first note; and
determine the key based on a comparison of the respective strengths of the at least second and third notes.

16. An apparatus as claimed in claim 15, wherein the predetermined fraction is determined in dependence on the content of the audio signal.

17. An apparatus as claimed in claim 16, wherein the predetermined fraction lies in the range of one tenth to one half.

18. An apparatus as claimed in claim 17, wherein the predetermined fraction is one seventh.

19. An apparatus as claimed in claim 15, wherein for each of a plurality of signal portions, to analyse the portion to identify a musical note the data processing apparatus is operable to:
convert the portion to a frequency domain representation;
subdivide the frequency domain representation into a plurality of octaves;
for each octave containing a maximum amplitude
determine a frequency value at the maximum amplitude; and
select a note name of a musical scale in dependence on the frequency value;
and
identify a musical note in dependence on the same note name being selected in more than one octave.

20. An apparatus as claimed in claim 19, wherein the data processing apparatus is operable to convert the portion to a frequency domain representation by performing a Fourier Transform.

21. An apparatus as claimed in claim 19, wherein the musical scale is the Equal Tempered Scale.

22. An apparatus as claimed in claim 15, wherein to determine a strength associated with the or each musical note the data processing apparatus is operable to:
determine the amplitude of each frequency component of the musical note; and
sum the amplitudes.

23. An apparatus as claimed in claim 15, wherein to determine the first note the data processing apparatus is operable to:
for each identified musical note, sum the strengths associated with the musical note in the data records; and
determine the first note to be the identified musical note with the maximum summed strength.

24. An apparatus as claimed in claim 15, further comprising an output device operable to send data corresponding to the key of the audio signal.

25. A record carrier comprising software operable to carry out the method of claim 1.

26. A software utility configured for carrying out the method steps as claimed in claim 1.

27. A jukebox including a data processor, said data processor being directed in its operations by a software utility as claimed in claim 26.

28. A method for determining the key of an audio signal substantially as hereinbefore described and with reference to the accompanying drawings.

29. An apparatus for determining the key of an audio signal substantially as hereinbefore described and with reference to the accompanying drawings.
